(19) United States
(12) Patent Application Publication
(10) Pub. No.: US 2015/0102026 A1
(43) Pub. Date: Apr. 16, 2015

(54) FUEL TANK FOR A VEHICLE WITH IMPROVED FIRE RESISTANCE AND METHOD FOR THE MANUFACTURE THEREOF

(71) Applicant: Plastic Components and Modules Automotive S.p.A., Grugliasco (Torino) (IT)

(72) Inventors: Enrico Parola, Borgaro Torinese (Torino) (IT); Pasquale Iacobone, Melfi (Potenza) (IT); Etienne Valentin, Torino (IT)

(21) Appl. No.: 14/515,891

(22) Filed: Oct. 16, 2014

(30) Foreign Application Priority Data
Oct. 16, 2013 (IT) TO2013A000837

(51) Int. Cl. B60K 15/03; B65D 81/02; B65D 6/34

(52) U.S. Cl. CPC B60K 15/03177; B65D 11/22; B65D 81/02
USPC 220/4.01

(57) ABSTRACT

A tank comprising a first and a second half-shell comprising a hydrocarbon barrier layer made of a first material and a structural containment layer made of a second material is described, wherein the material of the barrier layer is EVOH and the material of the structural containment layer is a mixture of polyethylene, an agent for promoting bonding with EVOH and a carbon nanotube filler.

The present invention relates to fuel tanks for vehicles and more specifically relates to a fuel tank with improved fire resistance according to the preamble of claim 1 and to a method for manufacturing a fuel tank with improved fire resistance according to the preamble of claim 9.

A fuel tank of a vehicle must have physical and structural characteristics which are determined by its intended use, the most important characteristic being the total or near-total impermeability to fuel vapours.

In order to obtain petrol-vapour impermeability characteristics various forming techniques for the production of multi-layer tanks are known, these comprising a barrier layer, typically made of ethyl vinyl alcohol (EVOH), and a containment or structural layer, typically made of polyethylene (PE), bonded to the barrier layer by means of intermediate adhesive layers.

Extrusion and blowing techniques may be used to obtain a single-piece, bowl-shaped, tank body having a multi-layer structure comprising an inner structural layer and an outer structural layer made of polyethylene and an intermediate barrier layer made of EVOH, whose joining with the polyethylene structural layers is ensured by means of compatibilizing adhesive layers. This type of shell may be obtained using extrusion and blowing machines equipped with a head for the simultaneous extrusion of several layers.

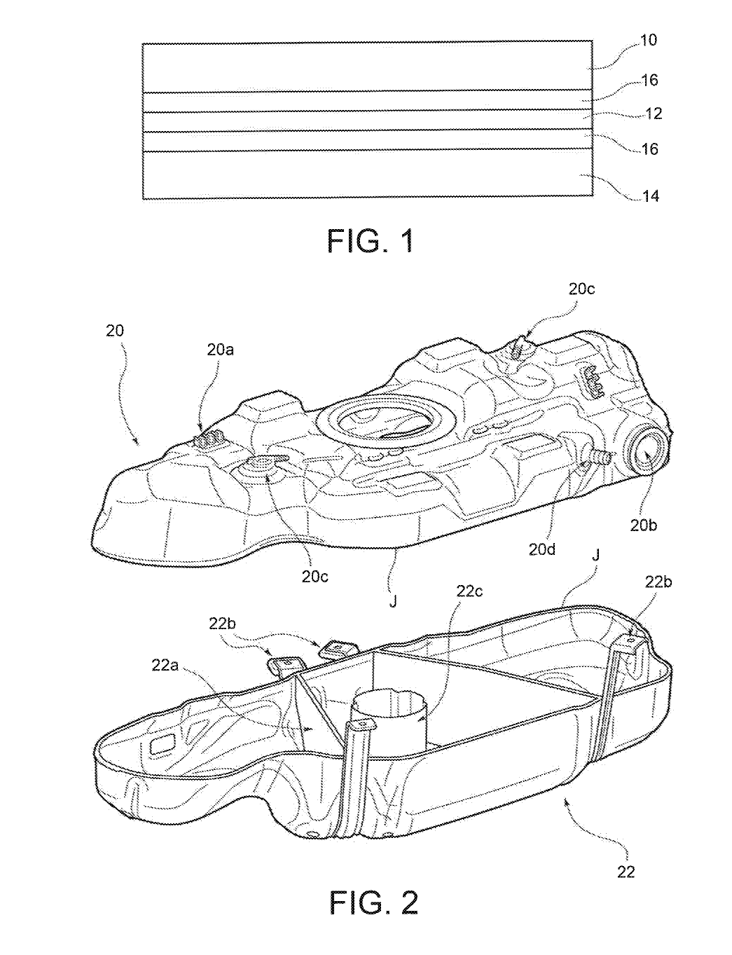

A wall section of the body of a tank obtained by means of extrusion and blowing techniques is shown in FIG. 1, where 10 denotes an inner layer of polyethylene for containing the liquid, 12 denotes a barrier layer made of EVOH, impermeable to petrol vapours, and 14 denotes a structural outer layer, again made of polyethylene. A compatibilizing adhesive layer 16, adapted to ensure bonding together of the two materials, which otherwise are incompatible, is arranged between each polyethylene layer and the EVOH intermediate layer.

Techniques for thermoforming multi-layer sheets constitute an alternative to extrusion and blowing and are able to produce separate half-shells with the same structure of alternate containment and barrier layers, these being then joined together by means of perimetral welding.

Injection moulding techniques for the manufacture of half-shells made of polyethylene material are known, these half-shells being then welded together to form a receptacle suitable for containing water, oil or gas fuel so that there is no risk of vapour permeability, but being unsuitable for creating a barrier for the vapours of hydrocarbons (fuels used in the automotive sector).

The strict European directives governing fuel tanks, in particular European Directive 70/221/CEE and the fire resistance type-approval standard defined in it under section 6.3.5., stipulate that a fuel tank for vehicles must satisfy predetermined fire resistance requirements when exposed to flames during a predetermined test period, following which there must not be any loss of liquid fuel.

The object of the present invention is to provide a multi-layer fuel tank which has improved fire resistance properties compared to the known tanks.

According to the present invention this object is achieved by means of a tank having the characteristic features mentioned in claim 1.

Particular embodiments form the subject of the dependent claims, the contents of which are to be understood as forming an integral part of the present description.

The invention relates furthermore to a method for manufacturing a tank with improved fire resistance properties as claimed.

In brief, the present invention is based on the principle of providing a fuel tank made of two opposite half-shells which are obtained by injection-moulding at least two layers of material, respectively a polyethylene material compatibilized with a carbon-based filler and a barrier material, for example EVOH, the half-shells being then joined together by means of laser welding. “Polyethylene material compatibilized with a carbon-based filler” is understood as meaning, in particular, a mixture of polyethylene and an agent for promoting bonding with EVOH, known in the art, such as a low-density polyethylene to which maleic anhydride has been added, further enriched with a carbon nanotube based filler in small percentage amounts by weight, for example 1 to 20% by weight and preferably 1 to 5% by weight.

Advantageously, the tank structure according to the invention has improved fire resistance properties due to the properties of the carbon nanotubes which migrate towards a flame-exposed surface area and form a protective mask against combustion for the rear-lying material.

Even more advantageously, the tank according to the present invention, which may be possibly obtained by means of the method claimed, has improved properties with regard to the welding together of component half-shells owing to the effect of the carbon-based filler, for example carbon nanotubes.

Further characteristic features and advantages of the invention will be described in greater detail in the following detailed description of an embodiment thereof provided by way of a non-limiting example, with reference to the accompanying drawings, in which:

FIG. 2 shows a three-dimensional illustration of two half-shells of a tank according to the invention;

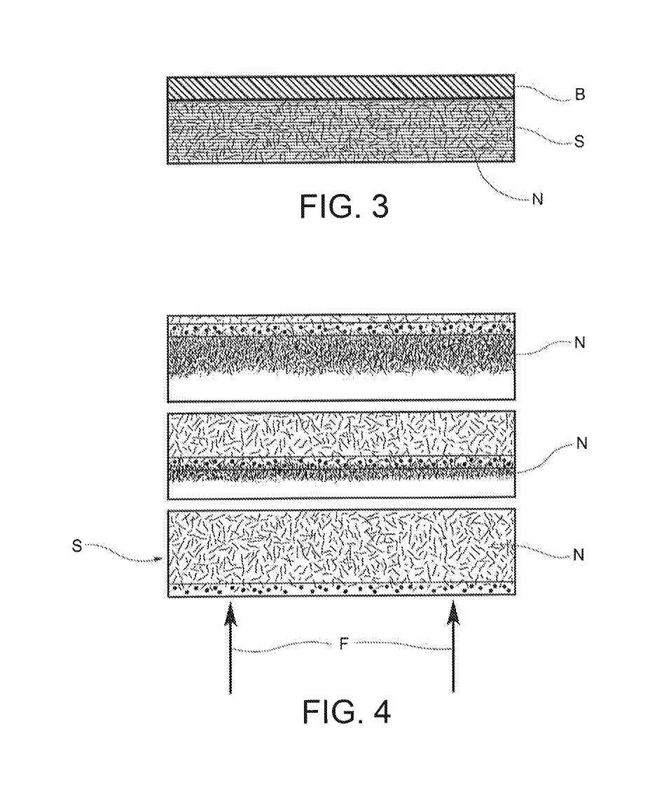

FIG. 3 shows a cross-sectional view of a wall of the tank half-shells according to the invention;

FIG. 4 is a diagrammatic illustration of the displacement of a carbon nanotube filler inside a polyethylene material matrix;

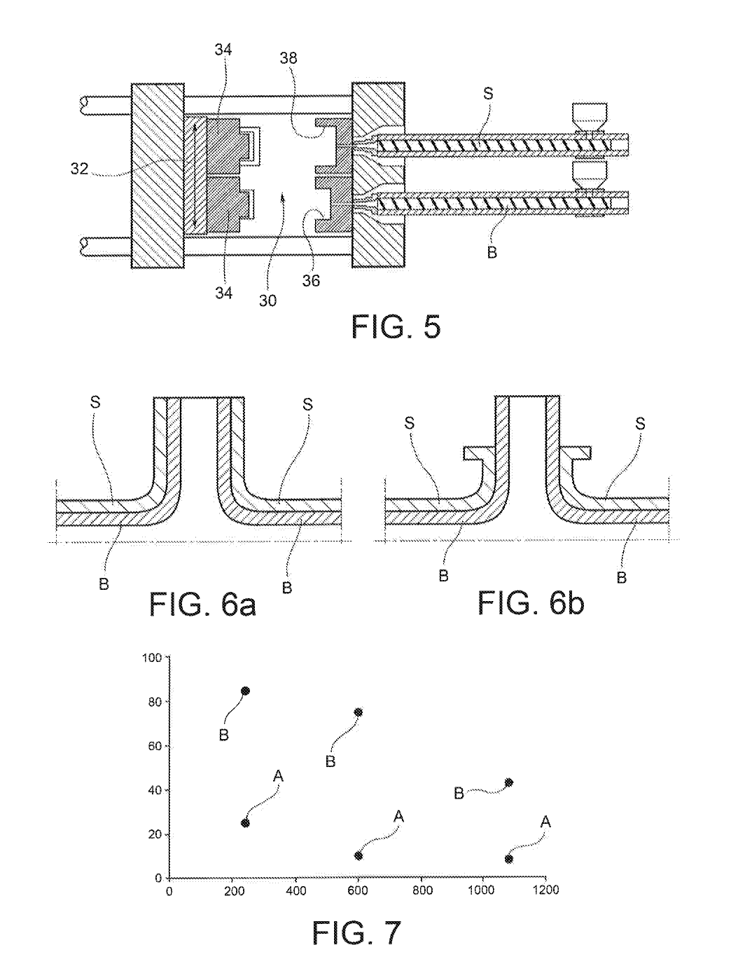

FIG. 5 is a diagrammatic illustration of a rotary mould used in a method for manufacturing a tank according to the invention;

FIGS. 6a and 6b are cross-sectional views of two embodiments of an opening formation in a half-shell of the tank; and

FIG. 7 is a comparative graph for the absorption of laser radiation in a material made of pure polyethylene and the absorption of laser radiation in a polyethylene material with 1% by weight of a carbon nanotube filler.

FIG. 2 shows two oppositely arranged half-shells 20, 22 of a fuel tank for a vehicle, which can be assembled together to form a tank body which is impermeable to hydrocarbons. As can be seen, the outer or convex surface of the half-shell 20 shown has a fastening system 20a for petrol-vapour pipes, a connection 20b for introducing the fuel, valve bodies 20c of a system for ventilating and recirculating air containing hydrocarbons, and a connection 20d for a breather duct. As can be seen, the inner or concave surface of the half-shell 22 shown has ribs 22a for reinforcing the tank structure, which also perform the function of anti-surge baffles, systems 22b for fixing the tank to the vehicle body and a calming reservoir 22c for a fuel suction unit.

The tank is advantageously a multi-layer tank comprising a first, outer, structural or containment layer S, made of a mixture of polyethylene material, for example HD-PE, of compatibilizing material, for example a low-density polyethylene to which maleic anhydride has been added, and of a carbon-based filler, such as a carbon nanotube filler N preferably of between 1% and 20% by weight, even more preferably a carbon nanotube filler of between 1 and 5% by weight. The tank comprises a second, inner, hydrocarbon bather layer B made of EVOH and stably bonded to the structural containment layer S owing to the effect of the compatibilizing material, the function of which is that of an agent promoting bonding with the EVOH, so as to ensure the structural integrity of the tank.

In an alternative embodiment the multi-layer tank comprises a first outer layer B forming a barrier against hydrocarbons and a second, inner, structural or containing layer S.

This structure is shown in diagrammatic form in FIG. 3.

From experiments carried out it is known that mixtures of polyethylene with small percentages (1%-5%) of carbon nanotubes of the MultiWall Carbon Nanotube (MCNT) type with a typical diameter of 10 nanometres and with an aspect ratio in the region of 1/100 may not only improve the structural characteristics of polyethylene, but acquire fire-retarding properties.

According to a preferred embodiment the half-shells 20, 22 of the tank are made in such a way as to form respectively an upper half-shell 20 and a lower half-shell 22 of the tank, where the terms “upper” and “lower” are used with reference to the mounting position of the tank on a vehicle. Said half-shells have a perimetral welding line J which lies preferably, but not necessarily, in a horizontal plane with respect to the mounting position of the tank on a vehicle.

Advantageously, only the lower half-shell 22 of the tank has a structural layer S with added carbon nanotube filler if the lower half-shell has a shape acting as a screen for the upper half-shell, the latter not being directly exposed to the flames in the event of a fire.

The mechanism which helps improve the fire resistance, namely increases the flame resistance time of the structural layer containing a carbon nanotube filler, may be described as follows, with reference to the diagrammatic illustration shown in FIG. 4:
migration and accumulation of the carbon nanotubes N towards the flame-exposed surface (indicated by the arrows F);
creation of a screening effect which limits, in this way, diffusion of the products of the degradation of the matrix of polyethylene material; and
achieving protection of the underlying polymer layers against oxidation, with a significant increase in the resistance and combustion times of the product.

Each half-shell is obtained by means of injection overmoulding of the component layers, carried out in two successive steps.

FIG. 5 shows a diagrammatic illustration of an injection system designed to implement an injection-moulding method according to the invention for the manufacture of a tank in the first embodiment, where the barrier layer B is the inner layer of the tank and the structural containment layer S is the outer layer.

In a same processing chamber 30 the system has a rotating or translating support 32 carrying a pair of identical punches 34 opposite which two differently shaped moulding dies are arranged, in particular a first moulding die 36 and a second moulding die 38, in order of operation, which are designed to mould a half-shell 20, 22 of the fuel tank. A first extruder unit for injecting the material forming the barrier layer B is associated with the first moulding die 36, and a second extruder unit for injecting the material forming the structural layer

S, preferably with an added compatibilizing substance, namely a substance for promoting the chemical/physical adhesion to the material forming the barrier layer B, is associated with the second moulding die 38.

The first moulding die 36 has a cavity with a predetermined shape, depending on the desired volume of the tank, which defines the inner surface of the tank and associated surface holes and opening formations.

The second moulding die 38 has a corresponding cavity, enlarged with respect to the cavity of the first moulding die 36, and in particular the cavity of the second moulding die 38 has overall a shape geometrically similar to the shape of the cavity of the first moulding die 36, but enlarged at least in one direction of extension of the mould, preferably in two directions of extension of the mould and even more preferably in the three perpendicular directions of the mould.

Advantageously, the shape of the cavity of the second moulding die may differ from the shape of the cavity of the first moulding die in one or more localized areas, of limited extension with respect to the surface of the entire die, in the areas where integrated accessory components are to be formed. This allows the moulding of said accessory components together with the structural layer S of a respective half-shell of the tank body.

During a first step of a method for the production of the tank, for each half-shell of the tank body, moulding of the barrier layer is performed on a punch 34 by means of the first die 36. Then the support 32 is rotated or displaced and a new punch is exposed to the first moulding die 36 for renewed moulding of the barrier layer of a new half-shell. At the same time the punch carrying the moulded barrier layer is exposed to the second moulding die 38 and overmoulding of the structural layer S is performed on it.

It should be noted that, for correct execution of this second overmoulding step, the second moulding die 38 must have a cavity forming an envelope of the punch and bather layer moulded on it, in at least one direction of extension of the half-shell perpendicular to the direction of mating of the die and punch, and preferably in each direction of extension of the half-shell perpendicular to the direction of mating of the die and punch. The step of overmoulding the material forming the structural layer must be carried out without any gap being formed between the layers. The material forming the structural layer may occupy the mould entirely or have recesses or gaps in the surface, as shown in FIGS. 6a and 6b. In this way it is advantageously possible to have opening formations of the barrier layer which emerge on the outside of the tank and which can be used, for example, to provide connections for a system for ventilating and recirculating air containing hydrocarbons, to which low-permeability pre-formed multi-layer pipes may be connected by means of quick-fixing systems, or provide integrally in the structural layer S, barrier layer B or both the layers projecting formations adapted to form an access inlet into the tank or connections to external ducts, for example formations including a connection for introducing the fuel or a connection for a pipe for ventilating air or vapours during supplying of the fuel.

Preferably, moulding is performed at a temperature of the nozzle for injecting the material of the structural layer S (for HDPE mixtures) ranging between 190° C. and 260° C., at a temperature of the nozzle for injecting the material of the barrier layer B (with EVOH) ranging between 170° C. and 260° C. and with a temperature of the mould of up to 80° C. and preferably constant operating pressures of between 20 bar and 50 bar. Since the co-injection and overmoulding are performed in the same processing chamber 30 for both the materials (layers), overmoulding of the structural layer S by means of the second die 38 is performed when the material of the barrier layer moulded by means of the first die 36 has a solid form, albeit not in a melt state, since it is not extracted from the chamber 30 of the injection system. For example, overmoulding of the structural layer is performed when the material of the barrier layer has a temperature higher than the ambient temperature and approximately at a temperature of the part ranging between 80° C. and 140° C., far from the moulding melting temperature of about 200° C.

Both the half-shells 20, 22 forming the tank body are moulded in the manner described.

The two moulded half-shells, which are subsequently cooled, are then joined together by means of known welding techniques (laser, vibration or infrared welding), for example butt-welding of the respective edges along the perimeter of the half-shells or using other contact or joining configurations between the half-shells—except for the tank access inlet so as to obtain at least continuous welding of the respective barrier layers.

The use of laser welding is to be preferred since it produces limited localized heating and melting effects, avoiding extensive deformation and deterioration of the materials.

The carbon nanotube filler N in a matrix of polyethylene material also provides a technological advantage in the tank manufacturing method.

It can be demonstrated that, in the case of welding of polymer materials by laser sources, especially the welding together of two sheets of polyethylene material, at least one of which has added carbon nanotubes, the presence of a carbon nanotube filler in low percentage amounts, in the region of 1-5%, increases the strength of the joint which is formed.

The carbon nanotubes act as catalysts of the radioactive absorption, increasing locally the absorption percentage of the radiation irradiated by means of a laser, raising it from 20-30% to threshold values of 80-90%, depending on the wavelength of the incident radiation.

FIG. 7 shows a graph comparing experimental results for the percentage absorption of laser radiation striking a material of pure polyethylene (A) at a wavelength of 240, 600 and 1080 nm and the percentage absorption of laser radiation striking polyethylene with 1% by weight of carbon nanotube filler (B) at the same wavelengths.

Conveniently, the joint which is created between the structural layers of the two half-shells 20, 22 of the tank, where the upper half-shell 20 has a structural layer formed by a mixture of polyethylene with an added compatibilizing agent for adhesion to the EVOH barrier layer, and the lower half-shell 22 has a structural layer formed by a mixture of polyethylene with an added compatibilizing agent for adhesion to the EVOH barrier layer and with a carbon nanotube filler, has mechanical resistance properties which are significantly improved since a perimetral welding seam with increased strength is formed along the perimetral welding line of the two half-shells.

The percentage of nanotube filler in the polymer matrix and the wavelength of the laser welding beam are the parameters which influence the mechanical strength of the weld.

The depth of the weld may be also be adjusted by modifying the amount of carbon nano-tube filler: low percentage amounts of about 1% by weight produce strong welds, while weak welds are produced by high percentage amounts (5% or more) of nanotubes.

The resultant tank has a continuous inner barrier layer B between the original half-shells and a structural outer layer S, which is overmoulded on the barrier layer, more firmly welded along the joining perimeter of the half-shells and which has improved fire resistance properties. In the embodiment shown, the structural layer has in localized areas formations for integrating functional components, such as valve bodies, pipes, level indicators, anti-surge baffles or retaining and fixing systems.

Obviously, without altering the principle of the invention, the embodiments and the constructional details may be greatly varied with respect to that described and illustrated purely by way of a non-limiting example, without thereby departing from the scope of the invention as defined in the accompanying claims.

1. Tank comprising a first and a second half-shell comprising a hydrocarbon barrier layer made of a first material and a structural containment layer made of a second material, forming respectively an inner hydrocarbon barrier layer and an outer structural containment layer, or an inner structural containment layer and an outer hydrocarbon barrier layer,
wherein said outer layer is overmoulded on said inner layer, wherein said half-shells are joined along a perimetral line of contact in such a way as to obtain at least continuity of the respective barrier layers, and
wherein the second material of said structural layer includes a carbon-based filler, characterized in that said carbon-based filler is a carbon nanotube filler.

2. Tank according to claim 1, wherein said first material adapted to form a barrier layer is EVOH and said second material adapted to form the structural containment layer is a mixture of polyethylene, an agent for promoting bonding with EVOH and a carbon nano-tube filler.

3. Tank according to claim 2, wherein said carbon nanotube filler is a filler of between 1% and 20% by weight.

4. Tank according to claim 3, wherein said carbon nanotube filler is a filler of between 1% and 5% by weight.

5. Tank according to claim 1, comprising an upper half-shell and a lower half-shell, wherein the second material adapted to form the structural containment layer of the upper half-shell is a mixture of polyethylene and an agent for promoting bonding with EVOH, and the second material adapted to form the structural containment layer of the lower half-shell is a mixture of polyethylene, an agent for promoting bonding with EVOH and a carbon nanotube filler.

6. Tank according to claim 1, wherein an outer layer has in localized areas formations for integrating functional components of the tank, and wherein said formations for integrating functional components of the tank include opening formations in the barrier layer and surface holes in the structural containment layer adapted to expose said opening formations of the barrier layer.

7. Tank according to claim 6, wherein said opening formations in the barrier layer and said surface holes in the structural containment layer include formations which project from the structural containment layer and/or the barrier layer and are adapted to form an inlet for accessing the tank or connections with external conduits.

8. Tank according to claim 1, wherein said carbon nanotube filler in the second material is adapted to migrate towards a flame- exposed surface area of said second material.

9. Method for manufacturing a fuel tank comprising a first and a second half-shell comprising a hydrocarbon barrier layer made of a first material and a structural containment layer made of a second material, forming respectively an inner hydrocarbon barrier layer and an outer structural containment layer, or an inner structural containment layer and an outer hydrocarbon barrier layer, wherein said outer layer is overmoulded on said inner layer,
wherein said half-shells are joined along a perimetral line of contact in such a way as to obtain at least continuity of the respective barrier layers, and
wherein the second material of said structural layer includes a carbon-based filler, characterized in that said carbon-based filler is a carbon nanotube filler,
wherein said carbon-based filler is a carbon nanotube filler comprising:
manufacturing a pair of complementary half-shells; and
perimetrally welding said half-shells,
characterized in that the manufacture of each of said pair of half-shells includes injection-moulding a first material adapted to form said barrier layer or said structural containment layer according to a predetermined three-dimensional shape, and subsequently injection-overmoulding a second material adapted to form said structural containment layer on said moulded barrier layer or respectively said barrier layer on said moulded structural containment layer.

10. Method according to claim 9, wherein the moulding of said first material is performed in a first die of the mould having a predetermined shape and the moulding of said second material is performed in a second die of the mould having a shape geometrically similar to the shape of the first die, but enlarged in at least one direction of extension of the mould.

11. Method according to claim 9, wherein perimetral welding of the half-shells comprises welding together the respective barrier layers of the half-shells and welding together the respective structural containment layers of the half-shells, and
wherein at least welding together of the respective structural containment layers of the half- shells is performed by means of laser radiation striking a perimetral line of contact between the half-shells.
